(19) United States
(12) Patent Application Publication
(10) Pub. No.: US 2006/0043772 A1
(43) Pub. Date: Mar. 2, 2006

(54) Baffle and system formed therewith

(75) Inventor: Henry E. Richardson, Washington, MI (US)

Correspondence Address: Scott A. Chapple, Suite 311, 401 South Old Woodward Avenue, Birmingham, MI, 48009, US

(73) Assignee: L&L Products, Inc., Romeo, MI (US)

(21) Appl. No.: 10/927,349

(22) Filed: Aug. 26, 2004

(51) Int. Cl. B62D 25/00

(52) U.S. Cl. 296/187.02

(57) ABSTRACT

There is disclosed a baffle. Preferably the baffle is employed for sealing or baffling within a pillar or other structure of an automotive vehicle, although not required.

### FIELD OF THE INVENTION

The present invention relates generally to a baffle for use within an automotive vehicle.

### BACKGROUND OF THE INVENTION

For many years, the transportation industry has been concerned with designing components for providing baffling, sealing, structural reinforcement or the like to automotive vehicles. For example, U.S. Pat. Nos. 5,755,486; 4,901,500; and 4,751,249 describe prior art devices. Generally, the components include expandable materials, which may or may not be combined with other materials for forming seals, baffles, structural reinforcements or the like that fit into one or more cavities of an automotive vehicle. Once the components are placed in the cavities of the vehicle, the expandable materials may be expanded to secure the components in the cavities. In the interest of continuing such innovation, the present invention seeks to provide a baffle for providing sealing, baffling, sound dampening, sound attenuation, combinations thereof or the like to an automotive vehicle.

### SUMMARY OF THE INVENTION

The present invention is directed to a baffle. The baffle typically includes a carrier, an expandable material and one or more fasteners for at least temporarily locating the baffle within a cavity of an automotive vehicle. The baffle is typically employed for providing baffling, sealing, sound attenuation, sound dampening or the like within or adjacent a structure (e.g., a rear pillar) of an automotive vehicle.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of an exemplary baffle in accordance with an aspect of the present invention.

FIG. 2 is a perspective view of the exemplary baffle of FIG. 1 applied to an automotive vehicle

FIG. 3 is a perspective view of another exemplary baffle in accordance with an aspect of the present invention.

FIG. 4 is a perspective view of the exemplary baffle of FIG. 3 applied to an automotive vehicle.

FIG. 5 is a perspective view of yet another exemplary bafflie in accordance with an aspect of the present invention.

FIG. 6 is a perspective view of the exemplary bafflie of FIG. 5 applied to an automotive vehicle.

### DETAILED DESCRIPTION OF THE PREFERRED EMBODIMENT

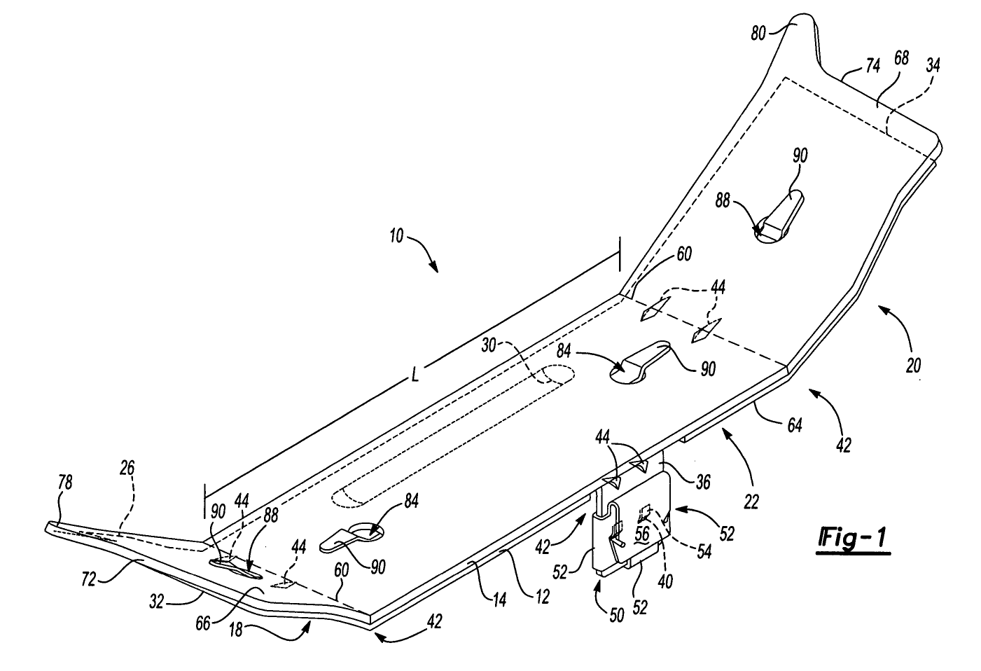

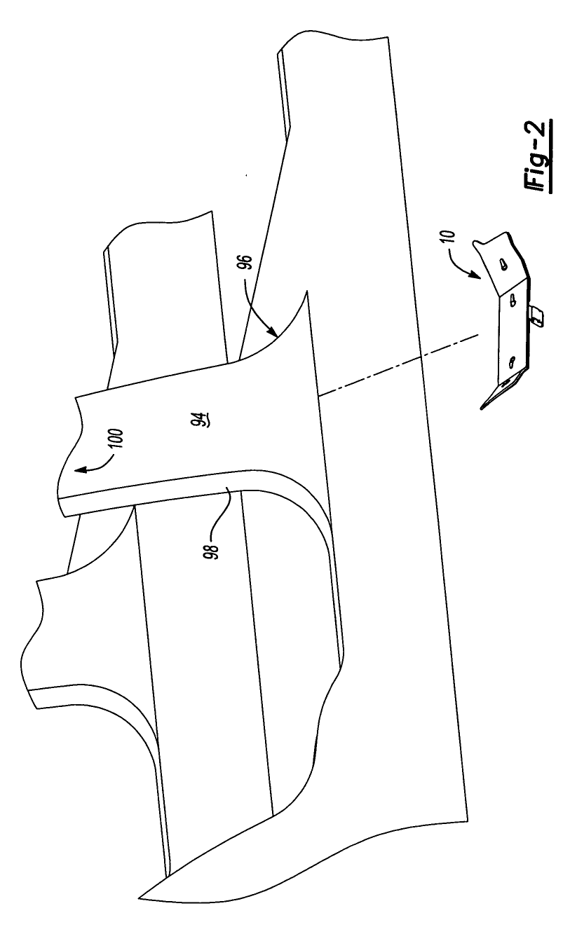

FIGS. 1-2 illustrate an example of a baffle 10 in accordance with the present invention. The baffle 10 includes a carrier 12 and a layer 14 of expandable material 14 fastened or otherwise attached to the carrier.

The carrier 12 is substantially entirely planar and includes a first planar end portion 18 opposite a second planar end portion 20 with a base or central planar portion 22 therebetween. Both of the end portions 18, 20 are disposed at an angle of between about 200 and about 400 relative to the central portion 22. One end portion 18 includes a flange 26 that is located at a side of the portion 18 and is bent at an angle relative thereto. Preferably, the flange 26 is cut directly from the portion 18.

The central portion 22 is generally rectangular and includes a channel 30 extending along a substantial amount (e.g., at least 60 or 70%) of a length (L) of the portion 22. Each of the end portions 18, 20 is also generally rectangular and each respectively includes an angled distal edge 32, 34.

A flange 36 extends from a lengthwise side of the central portion 22. As shown, the flange 36 is substantially planar and has generally square or rectangular shape. Moreover, as shown, the flange 36 is disposed at about a 90° angle relative to the central portion 22. The flange 36 also includes at least one, but preferably a pair of openings 40 (e.g., through-holes) extending into and/or through the flange 36.

Each of the end portions 18, 20 and the flange 36 are respectively attached to the central portion 22 with a bent interface portion 42. As shown, each of the bent interface portions 42 respectively include indents 44 for assisting in maintaining the bends of those portions 42 and, in turn, maintaining the end portions 18, 20 and flanges 36 at their positions or particular angles relative to the central portion 22.

Typically the baffle 10 includes one or more fasteners, which may be integral formed with the carrier 12 or layer 14 of expandable material as part of the same material or may be a separate component that is attached to the carrier 12 or layer 14. In the embodiment shown, the baffle 10 includes a fastener 50 that is a separate component that is attached to the flange 36 of the carrier 12. As shown, the fastener 50 is generally square or rectangular and includes one or plural (e.g., three) edges 52, which are folded over edges of the flange 36 for attaching the fastener 50 to the flange 36. The fastener 50 also includes one or plural (e.g., two) protrusions 54 extending into the openings 40 of the flange 36 for additionally assisting in attaching the fastener 50 to the flange 36. The fastener 50 also includes a flange 56 cantilevered over a body portion 58 of the fastener 50 and over the flange 36.

The layer 14 of expandable material overlays and is substantially coextensive with each of the portions 18, 20, 22 of the carrier 12. In the embodiment shown, the layer 14 is substantially entirely planar. The layer 14 includes two sets of perforations 60 extending across the layer 14 and dividing the layer 14 into a planar central portion 64 between planar end portions 66, 68. Advantageously, the perforations 60 assist in allowing the layer 14 to bend at locations corresponding to and adjacent the bends 42 of the carrier 12.

As shown, the planar central portion 64 and planar end portions 66, 68 of the layer 14 correspond to and oppose the central portion 22 and end portions 18, 20 of the carrier 12. Like the end portions 18, 20 of the carrier 12, the end portions 66, 68 of the layer 14 include angled distal edges 72, 74. Additionally, the end portions 66, 68 include protrusions 78, 80 extending from the most distal ends of the edges 72, 74.

Generally, the layer 14 includes one or a plurality of openings (e.g., through-holes) extending into and/or through the layer 14 for assisting in securing the layer 14 to the carrier 12. In the illustrated embodiment, the central portion 64 includes a pair of through-holes 84 at opposite ends of a length (L) thereof and each of the end portions 18, 20 have a centrally located through-hole 88.

As shown, tabs 90 of the carrier 12 extend through the openings 84, 88 and overlay the layer 14 for at least assisting in securing the layer to the carrier 12. The tabs 90 that extend through the through-holes 84, 88 in the central portion 64 extend away from each other in opposite directions toward respective end portions 66, 68. The tabs 90 that extend through the through-holes 88 in the end portions 66, 68 extend away from the central portion 64.

The carrier 12 including the portions 18, 20, 22, the flanges 26, 36, 56, the tabs 90 and the fastener 50 or combinations thereof may be integrally formed of a singular material or may be separately formed of different materials. Materials for the carrier and its respective components include, without limitation, metals or polymeric materials (e.g., nylon, polyamide, polyester, polypropylene, polyethylene or others), which may be filled or unfilled (e.g., filled with glass reinforcement fibers).

A variety of expandable materials may be used for the layer 14 of the baffle of the present invention. In one embodiment, the material may be formed of a heat activated material and may flow, cure (e.g., be thermosettable), foam or a combination thereof upon exposure to heat. The expandable material may be generally dry to the touch and substantially tack free or may be tacky and, in either situation, may be shaped in any form or desired pattern, placement, or thickness, but is preferably of substantially uniform thickness. One exemplary expandable material is L-7102 foam available through L&L Products, Inc. of Romeo, Mich. Another exemplary expandable material is disclosed in U.S. patent application titled “Expandable Material”, U.S. Ser. No. 10/867,835, filed on Jun. 15, 2004 and incorporated herein by reference for all purposes.

Though other heat-activated materials are possible, a preferred heat activated material is an expandable polymer or plastic, and preferably one that is foamable. Particularly preferred materials are epoxy-based, acrylate-based or acetate-based foams, which may be structural, sealing, sound damping, sound absorbing, sound attenuating or a combination thereof. For example, and without limitation, the foam may be an epoxy-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of epoxy-based or otherwise based sealing, baffling or acoustic foams are known in the art and may employed in the present invention. A typical foam includes a polymeric base material, such as an epoxy resin or ethylene-based polymer which, when compounded with appropriate ingredients (typically a blowing and curing agent), expands and cures in a reliable and predicable manner upon the application of heat or the occurrence of a particular ambient condition. From a chemical standpoint for a thermally-activated material, the structural foam is usually initially processed as a flowable thermoplastic material before curing. It will cross-link upon curing, which makes the material incapable of further flow.

One advantage of the preferred foam materials over prior art materials is that the preferred materials can be processed in several ways. The preferred materials can be processed by injection molding, extrusion, compression molding or with a mini-applicator. This enables the formation and creation of part designs that exceed the capability of most prior art materials.

While preferred materials have been disclosed, other materials may be used as well, particularly materials that are heat-activated or otherwise activated by an ambient condition (e.g. moisture, pressure, time, chemical reaction or the like) and cure in a predictable and reliable manner under appropriate conditions for the selected application. Of course, the material may also be formed of non-activatable materials, non-expandable materials or otherwise. Thus, upon activation, the material may soften, cure and expand; soften and cure only; cure only; soften only; or may be non-activatable.

One example of an expandable material is the epoxy based resin disclosed in U.S. Pat. No. 6,131,897, the teachings of which are incorporated herein by reference. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; and 5,932,680, (incorporated by reference). In general, the desired characteristics of the material include high glass transition temperature (typically greater than 70 degrees Celsius), and adhesion durability properties. In this manner, the material does not generally interfere with the materials systems employed by automobile manufacturers.

Other exemplary expandable materials can include combinations of two or more of the following: epoxy resin, polystyrene, styrene butadiene-styrene (SBS) block copolymer, butadiene acrylo-nitrile rubber, amorphous silica, glass microspheres, azodicarbonamide, urea, dicyandiamide. Examples of such materials are sold under the tradename SIKAELASTOMER, SIKAREINFORCER and SIKABAFFLE and are commercially available from the Sika Corporation, Madison Heights, Mich.

In applications where the material is a heat activated, thermally expanding material, an important consideration involved with the selection and formulation of the material comprising the foam is the temperature at which a material reaction or expansion, and possibly curing, will take place. Typically, the foam becomes reactive at higher processing temperatures, such as those encountered in an automobile assembly plant, when the foam is processed along with the automobile components at elevated temperatures or at higher applied energy levels, e.g., during paint or e-coat baking or curing steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the composition to cause expansion at different temperatures outside the above ranges. Generally, suitable expandable foams have a volumetric range of expansion ranging from approximately 0 to over 1000 percent (e.g., volumetric expansion of greater than 50%, 100%, 200%, 500%, 1000%, 1500% or 2000% of the original unexpanded volume of the material).

The material or medium may be at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) placed along the mold through the use of baffle technology; a die-cast application according to teachings that are well known in the art; pumpable application systems which could include the use of a baffle and bladder system; and sprayable applications.

Application

The baffle may be applied to a variety of locations upon a variety of articles of manufacture. It has been found, however, that the baffle is particularly suitable for application, acoustic dampening, baffling, sealing or a combination thereof within or adjacent a pillar (e.g., a forward or A-pillar, a central or B or C-pillar or a rearward or C or D-pillar) of an automotive vehicle. For example, the baffle may be located adjacent or within a cavity formed by the pillar for prohibiting or inhibiting the passage of material or sound through the cavity.

In FIG. 2, the baffle 10 has been located within a cavity 94 at or adjacent a base or lower portion 96 of a central pillar 98 and spans across the cavity 94. In the embodiment shown, the fastener 50 is attached to a portion of the body of the vehicle such as an inner panel, an outer panel, the pillar 98 or a combination thereof. Preferably, the flange 56 of the fastener 50 is slid over an edge of the portion of the vehicle to which the baffle 10 is at least temporarily fastened.

Upon activation, for instance from exposure to heat (e.g., in an e-coat or paint bake oven), the layer 14 of expandable material is activated to flow, expand, cure or any combination thereof such that the layer 14 of material contacts and adheres to walls forming the cavity 94. Typically, baffle 10 is positioned within the cavity 94 such that, upon activation of the expandable material, the foam formed thereby spans substantially entirely across the cavity forming a barrier wall inhibiting the passage of material or sounds through an upper portion 100 of the pillar 98.

### Alternative Embodiment

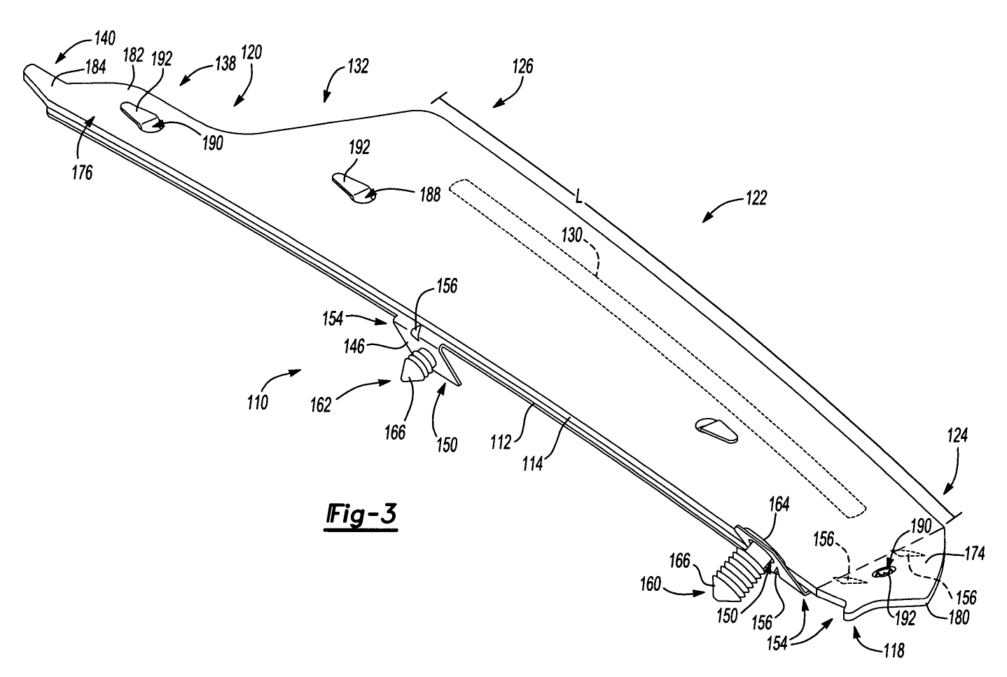

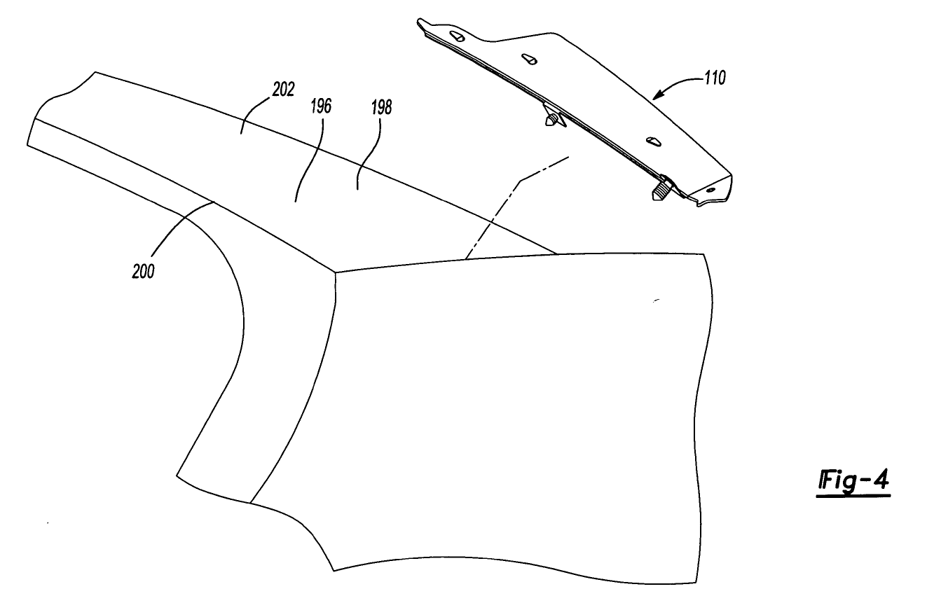

As discussed, the baffle of the present invention may be alternatively designed. As an example, FIGS. 3-4 illustrate one alternative embodiment of an alternative baffle 110 according to the present invention. The baffle 110 includes a carrier 112 and an expandable material 114.

The carrier 112 is substantially entirely planar and includes a first planar end portion 118 opposite a second planar end portion 120 with a base or central planar portion 122 therebetween. The first end portion 118 is disposed at an angle of between about 20° and about 40° relative to the central portion 122. The second end portion 120 is substantially coplanar with the central portion 122.

The central portion 122 is generally elongated and tapers from one end 124 of the portion 122 to another opposite end 126. The central portion 122 includes a channel 130 extending along a substantial amount (e.g., at least 60 or 70%) of a length (L) of the portion 122. Moreover, at least one end 124 of the central portion 122 includes an angled distal edge 132.

In the embodiment shown, the first end portion 118 tapers to a point 134 as it extends away from the central portion 122. The second end portion 120, as shown, extends from adjacent a side of the angled distal edge 132 of the central portion 122 and includes a thicker portion 138 that leads to a distal thinner portion 140.

A first flange 142 extends from a lengthwise side 144 of the central portion 122 adjacent the end 124 of the portion 122 and a second flange 146 extends from a central area of the central portion 122. As shown, each of the flanges 142, 146 is substantially planar and has a generally square or rectangular shape. Moreover, as shown, the first flange 142 is disposed at an obtuse angle relative to the central portion 122 and the second flange 146 is disposed at an acute angle relative to the central portion 122. In the embodiment shown, the first flange 142 extends away from the central portion 122 in a direction that is substantially opposite (i.e., within 15° of opposite) a direction that the second flange 146 extends away from the central portion 122. Each of the flanges 142, 146 also includes at least one openings 150 (e.g., a through-hole) extending into and/or through the flange 142, 146.

The first end portion 118 and the first and second flanges 142, 146 are each respectively attached to the central portion 122 with a bent interface portion 154. As shown, each of the bent interface portions 154 respectively include indents 156 for assisting in maintaining the bends of those portions 154 and, in turn, maintaining the end portion 118 and flanges 142, 146 at their positions or particular angles relative to the central portion 122.

Typically, the baffle 110 includes one or more fasteners, which may be integrally formed with the carrier 112 or layer 114 of expandable material as part of the same material or may be a separate component that is attached to the carrier 112 or layer 114. In the embodiment shown, the baffle 110 includes a first fastener 160 that is a separate component that is attached to the first flange 142 of the carrier 112 and a second fastener 162 that is a separate component that is attached to the second flange 146 of the carrier 112. As shown, each of the fasteners 160, 162 is a Christmas tree-type fastener with a cap 164 and an elongated portion 166 with multiple angled flanges. Also as shown, the elongated portion 166 is extended through the respective openings 150 of the respective flanges 142, 146 for interference fitting the fasteners 160, 162 to the flanges 142, 146.

The layer 114 of expandable material overlays and is substantially coextensive with each of the portions 118, 120, 122 of the carrier 112. In the embodiment shown, the layer 114 is substantially entirely planar. The layer 114 includes at least one set of perforations 170 extending across the layer 114 and dividing the layer 114 into a planar central portion 172 and a planar end portion 174. Advantageously, the perforations 170 assist in allowing the layer 112 to bend at a location corresponding to and adjacent the bend 154 of the carrier 112.

As shown, the planar central portion 172, the first planar end portions 174 and a second planar end portion 176 of the layer 114 correspond to and oppose the central portion 122 and end portions 118, 120 of the carrier 112. Like the end portions 118, 120 of the carrier 112, one end portion 174 of the layer 114 tapers to a point 180 while the other end portion 176 has a thicker portion 182 extending to a distal thinner portion 184.

Generally, the layer 114 includes one or a plurality of openings (e.g., through-holes) extending into and/or through the layer 114 for assisting in securing the layer 114 to the carrier 112. In the illustrated embodiment, the central portion 172 includes a pair of through-holes 188 toward opposite ends of a length (L) thereof and each of the end portions 174, 176 have a centrally located through-hole 190.

As shown, tabs 192 of the carrier 112 extend through the openings 188, 190 and overlay the layer 114 for at least assisting in securing the layer 114 to the carrier 112. The tabs 192 that extend through the through-holes 188 in the central portion 172 extend away from each other in opposite directions toward respective end portions 174, 176. The tabs 190 that extend through the through-holes 190 in the end portions 174, 176 extend away from the central portion 172.

The carrier 112, including the portions 118, 120, 122, the flanges 142, 146, the tabs 192 and the fastener 160,162 or combinations thereof, may be integrally formed of a singular material or may be separately formed of different materials. Materials for the carrier and its respective components include, without limitation, metals or polymeric materials (e.g., nylon, polyamide, polyester, polypropylene, polyethylene or others), which may be filled or unfilled (e.g., filled with glass reinforcement fibers).

The layer 114 of expandable material may be formed of any of the expandable materials discussed herein. Moreover, the expandable material may applied or processed according to any of the techniques discussed above.

Application

The baffle may be applied to a variety of locations upon a variety of articles of manufacture. It has been found, however, that the baffle is particularly suitable for application, acoustic dampening, baffling, sealing or a combination thereof within or adjacent a pillar (e.g., a forward or A-pillar, a central or B or C-pillar or a rearward or C or D-pillar) of an automotive vehicle. For example, the baffle may be located adjacent or within a cavity formed by the pillar for prohibiting or inhibiting the passage of material or sound through the cavity.

In FIG. 3, the baffle 110 has been located within a cavity 196 at or adjacent a base or lower portion 198 of a rear pillar 200 and spans across the cavity 196. In the embodiment shown, the first fastener 160 and second fastener 162 are attached to a portion of the body or frame of the vehicle such as an inner panel, an outer panel, the pillar 200 or a combination thereof. Preferably, the elongated portions 166 of the fasteners 160, 162 are inserted within openings (e.g., through-holes) in the portion of the body or frame of the vehicle.

Upon activation, for instance from exposure to heat (e.g., in an e-coat or paint bake oven), the layer 114 of expandable material is activated to flow, expand, foam, cure or any combination thereof such that the layer 114 of material contacts and adheres to walls forming the cavity 196. Typically, the baffle 110 is positioned within the cavity 196 such that, upon activation of the expandable material, the foam formed thereby spans substantially entirely across the cavity forming a barrier wall inhibiting the passage of material or sounds through the an upper portion 200 of the pillar 200.

### Alternative Embodiment II

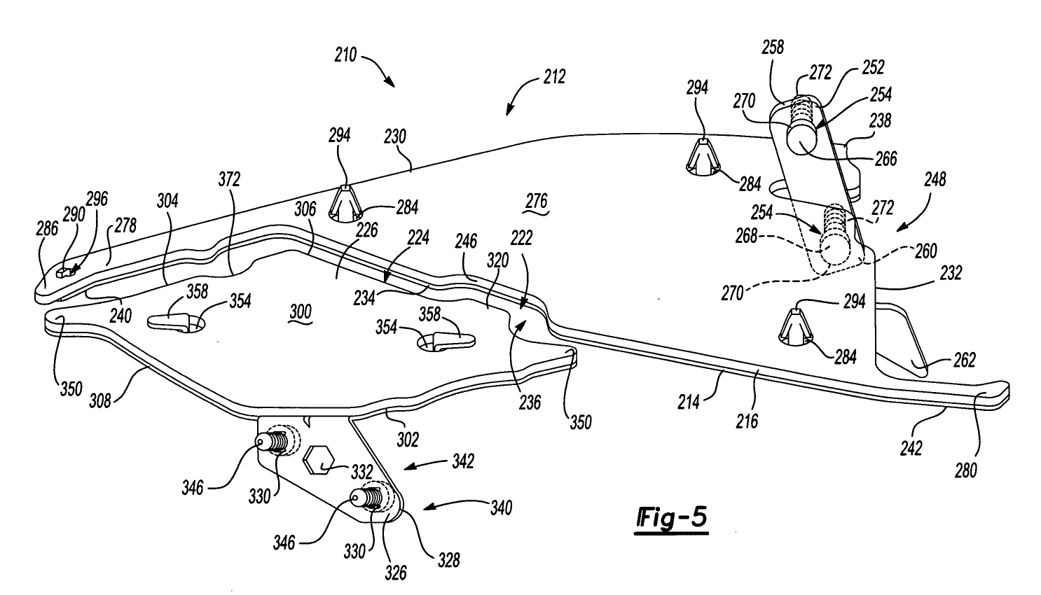

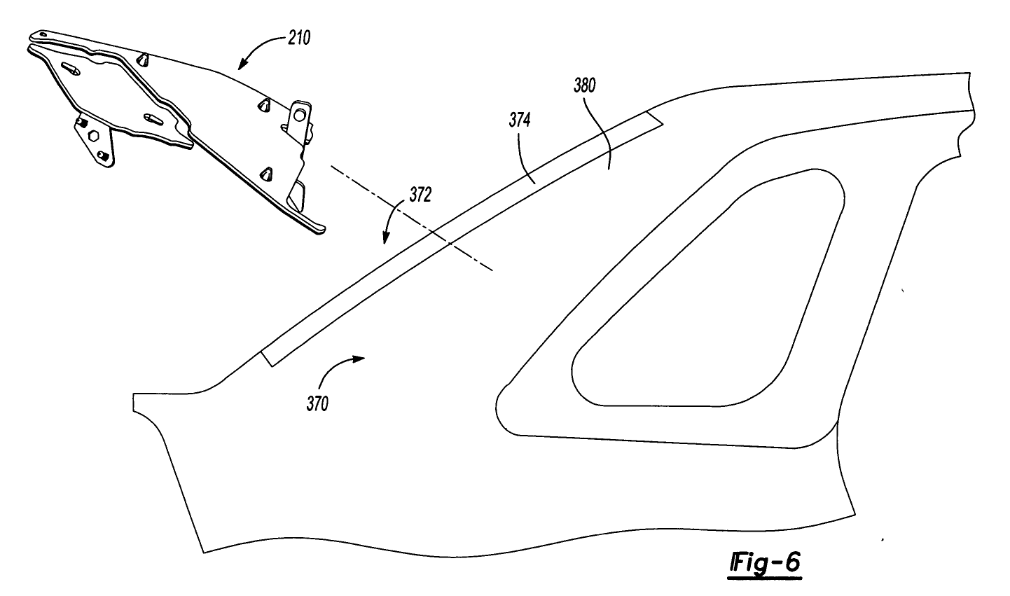

In one embodiment, the baffle of the present invention is a combination baffle, which includes a first baffle member and a second baffle member. As an example, FIGS. 5-6 illustrate a combination baffle 210 according to the present invention. The baffle 210 includes a first baffle member 212 having a carrier 214 and a layer 216 of expandable material and a second baffle member 222 also having a carrier 224 and a layer 226 of expandable material.

The carrier 214 of the first baffle member 212 is substantially entirely planar and includes a first side edge 230, a second side edge 232 and a third side edge 234 in a generally triangular configuration substantially defining a generally triangular generally planar body portion 236 of the carrier 214. The first side edge 230 and the second side edge 232 converge toward a point 238. The third side edge 234 and the first side edge 230 converge toward a first extension or finger 240. The third side edge 234 and the second side edge 232 converge toward a second extension or finger 242.

As shown, each of the side edges 230, 232, 234 is at least partially contoured. The third side edge 234 defines a cavity 246 and the second side edge 232 also defines a cavity 238. Moreover, the first side edge 230 is slightly arcuate along its length.

The carrier 214 also includes a planar member 252, which is generally elongated and rectangular shaped and extends substantially perpendicular to the body portion 236 of the carrier 214. As shown, the member 252 extends through a plane in which the body 236 of the carrier 214 is located. A pair of openings 254 (e.g., through-holes) is defined in the member 252 and are located toward opposite ends of the length (L) of the member 252. The member 252 is composed of a first flange 258 extending opposite a second flange 260. The carrier also includes a triangular flange 262 extending from one surface (e.g. a bottom surface) of the body portion 326 of the carrier 214 wherein the flange 262 is oriented substantially perpendicular to the surface, the body portion 236 or both.

Typically, the baffle member 212 includes one or more fasteners, which may be integrally formed with the carrier 214 or layer 216 of expandable material as part of the same material or may be a separate component that is attached to the carrier 214 or layer 216. In the embodiment shown, the baffle member 212 includes a first fastener 266 that is a separate component that is attached to the member 252 of the carrier 214 and a second fastener 268 that is a separate component that is attached to the member 252 of the carrier 214. As shown, each of the fasteners 266, 268 is a Christmas tree-type fastener with a cap 270 and an elongated portion 272 with multiple angled flanges. Also as shown, the elongated portion 272 is extended through the respective openings 254 of the respective flanges 258, 260 for interference fitting the fasteners 266, 268 to the flanges 258, 260.

The layer 216 of expandable material overlays and is substantially coextensive with the body 236 and the extensions 240, 242 of the carrier. Thus, the layer 216 has a body portion 276 and extensions 278, 280 corresponding to the body portion 236 and extensions 240, 242 of the carrier 214. In the embodiment shown, the layer 216 is substantially entirely planar.

As shown, the planar body portion 276 and planar extensions 278, 280 of the layer 216 correspond to and oppose the body portion 236 and extensions 240, 242 of the carrier 214. Like the body portion 236 of the carrier 214, the body portion 276 of the layer 216 is generally triangular.

Generally, the layer 216 includes one or a plurality of openings (e.g., through-holes) extending into and/or through the layer 216 for assisting in securing the layer 216 to the carrier 214. In the illustrated embodiment, the central portion 276 includes three through-holes 284 located respectively adjacent convergence locations of the sides 230, 232, 234 of the body portion 236 of the carrier 214. A through-hole 286 is also located at a distal end 290 of one extension 278.

As shown, arrowhead fasteners 294 of the carrier 214 extend through the openings 284 and overlap the layer 216 for at least assisting in securing the layer 216 to the carrier 214. Moreover, a tab 296 extends through the through-hole 286 in the extension 278 and then extends over the layer 216 for assisting in locating the extension 278 of the layer 216 over the extension 240 of the carrier 214.

The carrier 224 of the second baffle member 222 is substantially entirely planar and includes a body portion 300 having a first side edge 302 opposite a second side edge 304 and a third side edge 306 opposite a fourth side edge 308. The first side edge 302 and the third side edge 306 converge toward a first corner 310. The first side edge 302 and the fourth side edge 308 converge toward a second corner 312. The second side edge 304 and the third side edge 306 converge toward a third corner 316. The second side edge 304 and the fourth side edge 308 converge toward a fourth corner 118.

As shown, each of the side edges 302, 304, 306, 308 is at least partially contoured. The third side edge 306 defines a protrusion 320 and the second side edge 304 defines a cavity 322.

The carrier 224 also includes a flange 326, which extends outwardly to a generally arcuate edge 328 and is disposed substantially perpendicular to the body portion 300 of the carrier 224. A plurality of openings 330, 332 (e.g., through-holes) are defined in the flange 326 with one opening 330 adjacent the arcuate edge 328 and another opening being 332 relatively large for lowering the weight of the flange. Two of the openings 330 are located toward opposite edges of the flange 326.

Typically, the baffle member 222 includes one or more fasteners, which may be integrally formed with the carrier 224 or layer 226 of expandable material as part of the same material or may be a separate component that is attached to the carrier 224 or layer 226. In the embodiment shown, the baffle member 222 includes a first fastener 340 that is a separate component that is attached to the flange 326 of the carrier 224 and a second fastener 342 that is a separate component that is attached to the flange 326 of the carrier 224. As shown, each of the fasteners 340, 342 is a Christmas tree-type fastener with a cap 344 and an elongated portion 346 with multiple angled flanges. Also, as shown, the elongated portion 346 is extended through the respective openings 330 of the flange for interference fitting the fasteners 340, 342 to the flange 326.

The layer 226 of expandable material overlays and is substantially coextensive with the body 300 of the carrier 224. Thus, the layer 226 has first, second, third and fourth sides corresponding to the sides 302, 304, 306, 308 of the body portion 300 of the carrier 224. In the embodiment shown, the layer 226 is substantially entirely planar and includes two protrusions 350 at opposite corners of the layer 226.

Generally, the layer 226 includes one or a plurality of openings (e.g., through-holes) extending into and/or through the layer 226 for assisting in securing the layer 226 to the carrier 224. In the illustrated embodiment, the central portion 300 includes two through-holes 354 located respectively adjacent convergence locations of the sides 302, 304, 306, 308 of the body portion 300 of the carrier 224.

As shown, tabs 358 of the carrier 224 extend through the openings 354 and overlay the layer 226 for at least assisting in securing the layer 226 to the carrier 224. The tabs 358 that extend through the through-holes 354 extend away from each other in opposite directions toward the respective protrusions 350.

The carriers 214, 224, including the portions 236, 300, the flanges 258, 260, 262, 326, the tabs 358, 296 and the fasteners 294, 266, 268, 342, 340 or combinations thereof, may be integrally formed of a singular material or may be separately formed of different materials. Materials for the carrier and its respective components include, without limitation, metals or polymeric materials (e.g., nylon, polyamide, polyester, polypropylene, polyethylene or others), which may be filled or unfilled (e.g., filled with glass reinforcement fibers).

The layers 216, 226 of expandable material may be formed of any of the expandable materials discussed herein. Moreover, the expandable material may be applied or processed according to any of the techniques discussed above.

Application

The baffle and baffle members may be applied to a variety of locations upon a variety of articles of manufacture. It has been found, however, that the baffle is particularly suitable for application, acoustic dampening, baffling, sealing or a combination thereof within or adjacent a pillar (e.g., a forward or A-pillar, a central or B or C-pillar or a rearward or C or D-pillar) of an automotive vehicle. For example, the baffle may be located adjacent or within a cavity formed by the pillar for prohibiting or inhibiting the passage of material or sound through the cavity.

In FIG. 3, the baffle 210 has been located within one or more cavities 370 at or adjacent a middle portion 372 of a rear pillar 374 and spans across the one or more cavities 370. In the embodiment shown, the first and second fasteners 266, 268, 340, 342 are attached to portions of the body or frame of the vehicle such as an inner panel, an outer panel, the pillar 374 or a combination thereof. Preferably, the elongated portions 272, 346 of the fasteners 266, 268, 340, 342 are inserted within openings (e.g., through-holes) in the portion of the body or frame of the vehicle.

Advantageously, the baffle members 212, 222 are positioned such that the protrusion 320 of the second baffle member 222 extends toward the cavity 346 of the first baffle member 212. Moreover, the baffle members 212, 222, are positioned such that one side 234 of the first baffle member 212 is co-extensive with one side 306 of the second baffle member 222. It is contemplated that a member of the pillar may extend between the sides 234, 306 and the member may have a contour corresponding to and located between the protrusion 320 and cavity 246.

Upon activation, for instance from exposure to heat (e.g., in an e-coat or paint bake oven), the layers 216, 226 of expandable material are activated to flow, expand, foam, cure or any combination thereof such that the layer 216, 226 of material contact and adhere to walls forming the one or more cavities 370. Typically, baffle members 212, 222 are positioned within the one or more (e.g., two) cavities 370 such that, upon activation of the expandable material, the foam formed thereby spans substantially entirely across the one or more cavities forming a barrier wall inhibiting the passage of material or sounds through to an upper portion 380 of the pillar 374.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A baffle, comprising:
a substantially entirely planar carrier having a first planar end portion, a second planar end portion and a planar base portion with a first flange extending from a side of the base portion, wherein:
i) the first end portion is disposed at an angle of between about 20° and about 40° relative to the base portion;
ii) the base portion includes a channel extending along a substantial amount of a length of the base portion;
iii) the first flange is substantially planar and includes an opening extending through the first flange;
iv) the first end portion is connected to the base portion with a bent interface portion and the bent interface portion includes an indent for assisting in maintaining the positioning of the first flange relative to the base portion;
a fastener attached to the first flange;
a substantially planar layer of expandable material, wherein:
i) the layer includes a first set of perforations dividing the layer into a planar base portion and a first planar end portion, the perforations assisting the layer in bending at the perforations;
ii) the planar base portion, the first end portion and a second end potion of the layer of expandable material correspond to and overlay the base portion, the first end portion and the second end portion of the carrier;
iii) the layer includes a pair of through-holes at opposite ends of the length of the base portion and tabs extend through the through-holes of the base portion and overlap the layer;
iv) the first end portion and the second portion of the layer each include a through-hole and tabs extend through the through-holes of the end portions and overlap the layer.
wherein the baffle is configured to be located within or adjacent a central or rear pillar of an automotive vehicle such that, upon exposure to heat, the expandable material can foam, expand and contact walls of the pillar.

2. A baffle as in claim 1 wherein the base portion is generally rectangular and is located between the first end portion and the second end portion.

3. A baffle as in claim 1 wherein the carrier includes a second flange extending from the side of the base portion, the second flange including an opening with a fastener extending therethrough.

4. A baffle as in claim 1 wherein the first flange is disposed substantially perpendicular to the base portion.

5. A baffle as in claim 1 wherein a second flange is located at a side of the first end portion and is bent at an angle relative thereto and the second flange is cut directly from the first end portion.

6. A baffle as in claim 1 wherein the fastener attached to the first flange includes three edges folded over the first flange.

7. A baffle as in claim 6 wherein the fastener attached to the first flange includes two protrusions extending into openings of the first flange and includes a fastener flange cantilevered over a body portion of the flange.

8. A baffle as in claim 1 wherein the end portions of the layer include angled distal edges corresponding to angled distal edges of the end portions of the carrier.

9. A baffle as in claim 1 wherein the base portion tapers from one end to another.

10. A baffle as in claim 1 wherein the body portion and the flange of the carrier are integrally formed of a metal material.

11. A baffle as in claim 1 wherein the expandable material is a heat activated thermosetting material that foams, expands and cure upon exposure to temperature in an e-coat or bake oven.

12. A baffle, comprising:
a substantially entirely planar carrier having a first planar end portion, a second planar end portion and a generally rectangular base planar portion therebetween with a first flange extending from a side of the central portion, wherein:
i) both of the end portions are disposed at an angle of between about 20° and about 40° relative to the base portion and the first flange is disposed substantially perpendicular to the base portion;
ii) a second flange is located at a side of the second end portion and is bent at an angle relative thereto and the second flange is cut directly from the second end portion;
iii) the base portion includes a channel extending along a substantial amount of a length of the base portion;
iv) the first flange is substantially planar and includes a pair of openings extending through the first flange;
v) the first end portion, the second end portion and the first flange are each connected to the base portion with bent interface portions and each of the bent interface portions includes an indent for assisting in maintaining the positioning of the end portions and the first flange relative to the base portion;
a fastener attached to the first flange, wherein:
i) the fastener includes three edges folded over the first flange;
ii) the fastener includes two protrusions extending into openings of the first flange;
iii) the fastener includes a fastener flange cantilevered over a body portion of the flange;
a substantially planar layer of expandable material, wherein:
i) the layer includes a first set and a second set of perforations dividing the layer into a planar base portion between planar end portions and assisting the layer in bending at the perforations;
ii) the planar base portion and end portions of the layer of expandable material correspond to and overlay the central portion and end portions of the carrier;
iii) the end portions of the layer include angled distal, edges corresponding to angled distal edges of the carrier;
iv) the layer includes a pair of through-holes at opposite ends of the length of its base portion and tabs extend through the through-holes of the base portion and overlap the layer;
v) the end portions of the layer each include a through-hole and tabs extend through the through-holes of the end portions and overlap the layer.
wherein the baffle is configured to be located within a lower portion of a central pillar of an automotive vehicle such that, upon exposure to heat, the expandable material can foam, expand and contact wall of the pillar.

13. A baffle as in claim 12 wherein the expandable material is a heat activated thermosetting material that foams, expands and cure upon exposure to temperature in an e-coat or bake oven.

14. A baffle, comprising:
a first baffle member that includes a substantially planar first carrier and a substantially planar first layer of expandable material overlaying and opposing the first carrier, wherein:
i) the first carrier includes a body portion having a first side edge and second side edge converging to a point, the second side edge and a third side edge converging to a first extension and the third side edge and the first side edge converging to a second extension;
ii) the first carrier includes a member substantially perpendicular to the body portion of the carrier, the member being composed of a first flange and a second flange, each of the first and second flanges including an opening; and
iii) a first fastener and second fastener respectively extend through the opening in the first flange and the opening in the second flange;
iv) a plurality of carrier fasteners are integral with the body portion of the carrier and extend through openings in the first layer of expandable material; and
v) the first carrier and first layer define a cavity along the first side edge of the carrier;
a second baffle member that includes a substantially planar second carrier and a substantially planar second layer of expandable material overlaying and opposing the second carrier, wherein:
i) the second carrier includes a planar body portion having a first side edge opposite a second side edge and a third side edge opposite a fourth side edge, the third side edge defining a protrusion along with the second layer of expandable material;
ii) the second carrier includes a flange extending from the first side edge of the body portion, the flange having a pair of openings;
iii) a pair of fasteners extending through the pair of openings of the flange of the body portion of the second carrier; and
wherein the first baffle member and second baffle member are configured for insertion within a lower portion of a rear pillar of an automotive vehicle such that the protrusion of third side edge of the second baffle member corresponds to and aligns with the cavity along the third side edge of the carrier and such that, upon exposure to heat, the expandable material can foam, expand and contact walls of the pillar.

15. A baffle as in claim 14 wherein the first baffle member and second baffle member are configured to receive a member of the pillar therebetween.

16. A baffle as in claim 15 wherein the third side edge of the first baffle member is coextensive with the third side edge of the second baffle member.

17. A baffle as in claim 4 wherein the carrier fasteners are arrowhead shaped.

18. A baffle as in claim 17 wherein the first carrier and carrier fasteners are plastic.

19. A baffle as in claim 18 wherein the second carrier is metal.

20. A baffle as in claim 18 wherein the expandable material is a heat activated thermosetting material that foams, expands and cure upon exposure to temperature in an e-coat or bake oven.
